(19) United States
(12) Patent Application Publication
(10) Pub. No.: US 2016/0356035 A1
(43) Pub. Date: Dec. 8, 2016

(54) System and Method for Removing Moisture From An Interior Wall Of A Building

(71) Applicants: Chris Laney, Churubusco, IN (US); Gerrett Stier, Fort Wayne, IN (US)

(72) Inventors: Chris Laney, Churubusco, IN (US); Gerrett Stier, Fort Wayne, IN (US)

(21) Appl. No.: 15/238,261

(22) Filed: Aug. 16, 2016

Related U.S. Application Data
(63) Continuation-in-part of application No. 14/461,642, filed on Aug. 18, 2014.

(51) Int. Cl. E04B 1/70; F24F 13/24; F24F 7/10; F26B 21/00; F24F 13/02

(52) U.S. Cl. CPC E04B 1/7069; F26B 21/001; F26B 21/004; F26B 21/003; F24F 13/0218; F24F 7/10; F24F 13/24; F24F 2221/17

(57) ABSTRACT

A system for removing moisture from an interior wall of building, said system comprising: a blower, said blower comprising: a housing, said housing having an air intake port and an air outlet port; an electric motor, said motor disposed within said housing; and an impeller, said impeller functionally connected to said motor; a flexible blower air duct, said air duct comprising: an interior surface; an exterior surface; and at least one bore disposed through said air duct between said interior surface and said exterior surface; at least one nozzle, each said at least one nozzle removably attached to said air duct about each said at least one blower bore; and at least one flexible air hose, each said at least one air hose having: a first end, said first end removably attached to each said nozzle; and a second end.

### CROSS REFERENCE To RELATED APPLICATIONS

This is a continuation-in-part of U.S. patent application Ser. No. 14/461,642, entitled, “Electrical Drying Outlet Boot,” filed, Aug. 18, 2014, the disclosure of which is incorporated herein by reference.

### BACKGROUND

1. Field of the Art

The present invention relates generally to devices used to remove moisture from physical structures. More specifically, the present invention relates to an attachment for connecting a water removal device around electrical outlets in the walls of homes and other buildings.

2. Description of the Prior Art

Water damage restoration is the process of restoring a property back to pre-loss condition after sustaining any level of water damage. While there are currently no government regulations in the United States dictating procedures, there are standards for water damage restoration.

A professional water damage restoration service documents the materials that are affected by the water damage and refers to industry standard pricing guides in order to determine the proper value of the residence's materials lost and their service.

Water damage services include the inspection of the affected area(s) with water sensing equipment such as probes and other infrared tools in order to determine the source of the damage, and possible extent of area affected. Restoration services would then be rendered to the residence in order to dry the structure, sanitize any affected or cross contaminated areas, and deodorize all affected areas and materials. After the labor is completed, water damage equipment including, but not limited to, air movers, air scrubbers, dehumidifiers, wood floor drying systems, and sub floor drying equipment is left in the residence. After a period of two to three days are the labor is completed, a reevaluation of the residence is taken to monitor the drying process, and any equipment not further needed is removed as to keep the charges under control.

One of the first steps in any water damage restoration project is to remove excess water and moisture from the building. During the process removing water, the interior walls of a building need to be addresses with fans and other air movers. Those of skill in the art, often remove electrical outlets so that air can flow into the space between dry wall brackets. When electrical outlets are not removed, it is still desirable to maximize the flow of air into the walls. In either of these instances, those of skill in the art often connect a hose from an air mover to the a wall via the hole left by a removed outlet or connect a hose around the outlet using zip ties, duct tape or other crude methods. Unfortunately, these methods do not reliably connect a vacuum hose to a wall in the desired location.

For example, U.S. Pat. No. 3,684,819 discloses a flexible boot for an electrical receptacle having an open end and a closed end, and a peripheral, outwardly-extending, resilient flange which depends from the open end. The closed end of the boot is provided with areas of reduced thickness which are adapted to be pierced by electrical leads connected to the receptacle. The boot is employed in combination with an electrical outlet box and a receptacle situated therein so that the receptacle is surrounded by the boot and the resilient flange of the boot is held between the outer rim of the outlet box and a flange on the receptacle in a sealing relationship.

Another prior art reference, U.S. Pat. No. 4,134,636, discloses the combination of an electrical outlet box with an under plate wherein the outlet box has end walls and side walls and the under plate is a molded plastic insulator panel having a center tubular portion sized for telescopic engagement with the outlet box, the center portion being a continuous wall defining an open center area in the plate, and the plate having a continuous peripheral portion for engaging a building surface when the outlet box is positioned in a hole in such surface, and the center portion insulating terminal portions of an associated outlet receptacle.

Another prior art reference, U.S. Pat. No. 5,212,351 discloses an insulating boot for use with an electrical device that is attached to an outlet box. The box is attached to wall studs and may hold one or more electrical device, such as snap or dimmer switches, electrical outlets, television cables, telephone jacks and the like. The boot is made of a non-conducting, elastic material in the form of a strip the ends of which adhere to form a loop that snaps around the circumference of the device. A second strip follows a second circumference around the back of the device and attaches by adhering to the first strip at a position between the ends of the first strip so as to interfere with the attachment of the two ends of the first strip. The insulating boot prevents the shorting of the terminal of a device against the grounded outlet box wall or against the terminals of an adjacent device.

U.S. Pat. No. 7,331,759 discloses a drying fan, including for water damage restoration, including for drying a room corner extending axially along an interface between a wall and a floor, has a shrouded housing having an axial flow path therethrough, an intake cowling receiving intake air, and an exhaust cowling discharging exhaust air and having a tapered ramp both a) expanding the airflow and b) directing the airflow where desired.

U.S. Pat. No. 8,468,716 discloses a system for drying structures including an enclosed housing with a plurality of outlet openings, a plurality of flexible outlet hoses each connected to a respective outlet opening, and a vacuum motor engaged with the housing such that an outlet of the vacuum motor is exhausted into an interior of the housing so as to pressurize the interior of the housing such that compressed air is directed through the plurality of outlet hoses. Also a method of drying an interior of a structure, including placing a pressurized drying system adjacent a region of a structure, forming a plurality of openings in surfaces of the structure where the surfaces define enclosed spaces, inserting distal ends of outlet hoses of the pressurized drying system into respective openings of the surfaces of the structure, and engaging the pressurized drying system so as to generate a flow of pressurized air and to direct the pressurized air into the enclosed spaces.

U.S. Pat. No. 8,640,360 discloses an overall restoration system useful in removing moisture from structures is provided. The contemplated system includes a power and control device, a series of sensors, and a number of various different drying equipment, all capable of communication with a remote server. The system is highly portable, flexible and cost-efficient to manufacture and operate.

U.S. Pat. No. 8,978,270 discloses a method for drying or removing water from a wall cavity or structure without the need to tear to make holes, tear apart the structure, or use suction cups. The method uses a reversible portable moisture removal system for flowing pressurized heated air at a targeted location and for creating a vacuum to withdraw moist air from the wall cavity or structure a the moisture removal housing. The method dries wet walls in less time than current systems while also being reversible to remove moist air from wall cavities and structures.

U.S. Pat. No. 9,051,727 discloses a reversible portable moisture removal system for drying a structure or wall cavity without creating holes in the structure or wall cavity. The system has a moisture removal housing, which comprises an intake means, a blower, an air heater, a pressure controller and an outlet port. The system also has a docketing station connected to a flexible conduit for flowing pressurized heated air at a targeted location and for creating a vacuum to withdraw moist air from the structure or wall cavity to the moisture removal housing.

However, none of the known prior art discloses a device suitable for connecting water removal devices from the interior walls of homes and from around electrical outlets reliably and without removing the outlets. The present invention addresses these and other omissions of the prior art.

### SUMMARY

In one exemplary embodiment of the present invention, a system for removing moisture from an interior wall of building comprises: a blower, said blower comprising: a housing, said housing having an air intake port and an air outlet port; an electric motor, said motor disposed within said housing; and an impeller, said impeller functionally connected to said motor; a flexible blower air duct, said air duct comprising: an interior surface; an exterior surface; and at least one bore disposed through said air duct between said interior surface and said exterior surface; at least one nozzle, each said at least one nozzle removably attached to said air duct about each said at least one blower bore; and at least one flexible air hose, each said at least one air hose having: a first end, said first end removably attached to each said nozzle; and a second end.

In one exemplary embodiment of the present invention, a system for removing moisture from an interior wall of building comprises: a blower, said blower comprising: a housing, said housing having an air intake port and an air outlet port; an electric motor, said motor disposed within said housing; and an propeller, said propeller functionally connected to said motor; a flexible blower air duct, said air duct comprising: an interior surface; an exterior surface; and at least one bore disposed through said air duct between said interior surface and said exterior surface; at least one nozzle, each said at least one nozzle removably attached to said air duct about each said at least one blower bore; at least one flexible air hose, each said at least one air hose having: a first end, said first end removably attached to each said nozzle; and a second end; a vacuum, said vacuum comprising: a housing, said housing having at least one an air intake port and an air outlet port; an electric motor, said motor disposed within said housing; and an impeller, said impeller functionally connected to said motor; an electrical outlet boot, said boot removably disposed over an electrical outlet; and a vacuum air duct, said vacuum air duct having: a first end, said first end of said vacuum air duct attached to said air intake port; and a second end, said second end of said vacuum air duct attached to said boot.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only. In the drawings:

FIG. 1 shows a system in accordance with the present invention.

FIG. 2 shows a blower component in accordance with the present invention.

FIG. 3 shows a sound dampening box in accordance with the present invention.

FIG. 4 shows a blower air duct in accordance with the present invention.

FIG. 5 shows an assembly view and an exploded view of a nozzle in accordance with the present invention.

FIG. 6 shows a nozzle hose in accordance with the present invention.

FIG. 7 shows perspective, top, rear, and side views of a vacuum device in accordance with the present invention.

FIG. 8 shows an exploded view of a vacuum device accordance with the present invention.

FIG. 9 shows a top perspective view of an inlet plate assembly for an air scrubber/vacuum device in accordance with the present invention.

FIG. 10 shows an exploded perspective view of the device of FIG. 9.

FIG. 11 shows a perspective view of an exemplary HEPA filter assembly in accordance with the present invention.

FIG. 12 shows an exploded perspective view of the device in FIG. 11.

FIG. 13 shows a perspective view of an exemplary fan assembly for use with the present invention.

FIG. 14 shows an exploded perspective view of the device in FIG. 13.

FIG. 15 shows a perspective view of an exemplary fan housing weldment for use of the present invention.

FIG. 16 shows an exemplary motor fan assembly for use with the present invention.

FIG. 17 shows an exploded perspective view of the motor fan assembly of FIG. 16.

FIG. 18 shows an exemplary vacuum hose in accordance with the present invention.

FIG. 19 shows a top perspective view of an exemplary outlet boot according to the present invention.

FIG. 20 shows a bottom perspective view of an exemplary outlet boot according to the present invention.

FIG. 21 shows a side view of an exemplary outlet boot according to the present invention in a first vertical orientation.

FIG. 22 shows a side view of an exemplary outlet boot according to the present invention in a second vertical orientation.

FIG. 23 shows a bottom perspective view of an exemplary outlet boot according to the present invention with an interior bracket attached.

FIG. 24 shows a bottom perspective view of an exemplary outlet boot according to the present invention without an interior bracket attached.

FIG. 25 shows a perspective view of an exemplary outlet boot according to the present invention with the device attached to a wall.

FIG. 26 shows a top view of an exemplary outlet boot according to the present invention with the device attached to a wall.

FIG. 27 shows a side view of an exemplary outlet boot according to the present invention with the device attached to a wall.

Corresponding reference characters indicate corresponding parts throughout the several views. The exemplary embodiments set forth herein are not to be construed as limiting the scope of the invention in any manner.

### DETAILED DESCRIPTION OF THE EMBODIMENTS

The present invention will be discussed hereinafter in detail in terms of various exemplary embodiments according to the present invention with reference to the accompanying drawings. In the following detailed description, numerous specific details are set forth in order to provide a thorough understanding of the present invention. It will be obvious, however, to those skilled in the art that the present invention may be practiced without these specific details. In other instances, well-known structures are not shown in detail in order to avoid unnecessary obscuring of the present invention.

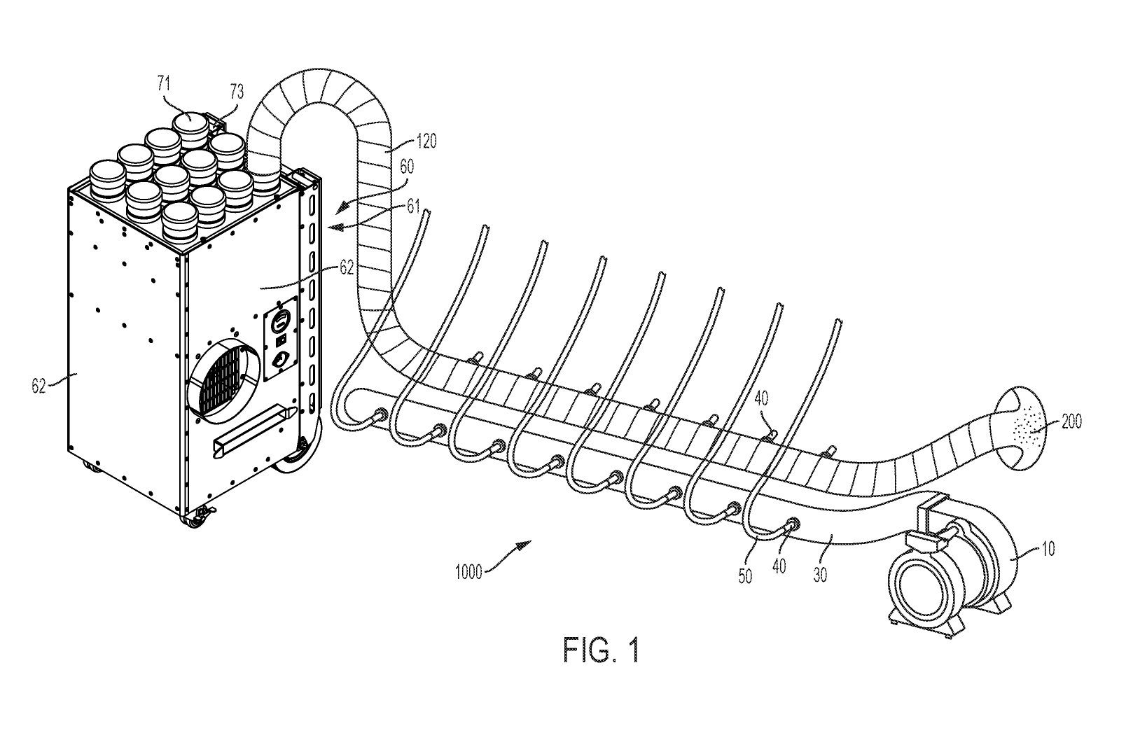

Thus, all of the implementations described below are exemplary implementations provided to enable persons skilled in the art to make or use the embodiments of the disclosure and are not intended to limit the scope of the disclosure, which is defined by the claims. As used herein, the word “exemplary” or “illustrative” means “serving as an example, instance, or illustration.” Any implementation described herein as “exemplary” or “illustrative” is not necessarily to be construed as preferred or advantageous over other implementations. Moreover, in the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring first to FIG. 1, there is shown system 1000 in accordance with the present invention. As illustrated in FIG. 1, system 1000 generally comprises: blower 10, blower box 20 (not shown), blower air duct 30, nozzles 40, nozzle hoses 50, vacuum 60, vacuum air duct 120, and outlet ceiling boot 200. As further illustrated in FIG. 1, blower 10 is fluidly connected to one end of blower air duct 30. A plurality of nozzles 40 are distributed along and through blower air duct 30 along a generally straight line. In certain embodiments of the present invention, a second plurality of nozzles is disposed through blower air duct 30 or disposed through blower air duct 30 on an opposing side of blower air duct 30. Each nozzle 40 is releasably attached to a nozzle hose 50.

Referring still to FIG. 1, system 1000 in the present invention further comprises air scrubber/vacuum apparatus 60 and vacuum air duct 120. Vacuum air duct 120 has two ends. The first end of vacuum air duct 120 is fluidically connected to vacuum 60. The second side of vacuum air duct 120 is fluidically connected to outlet boot 200.

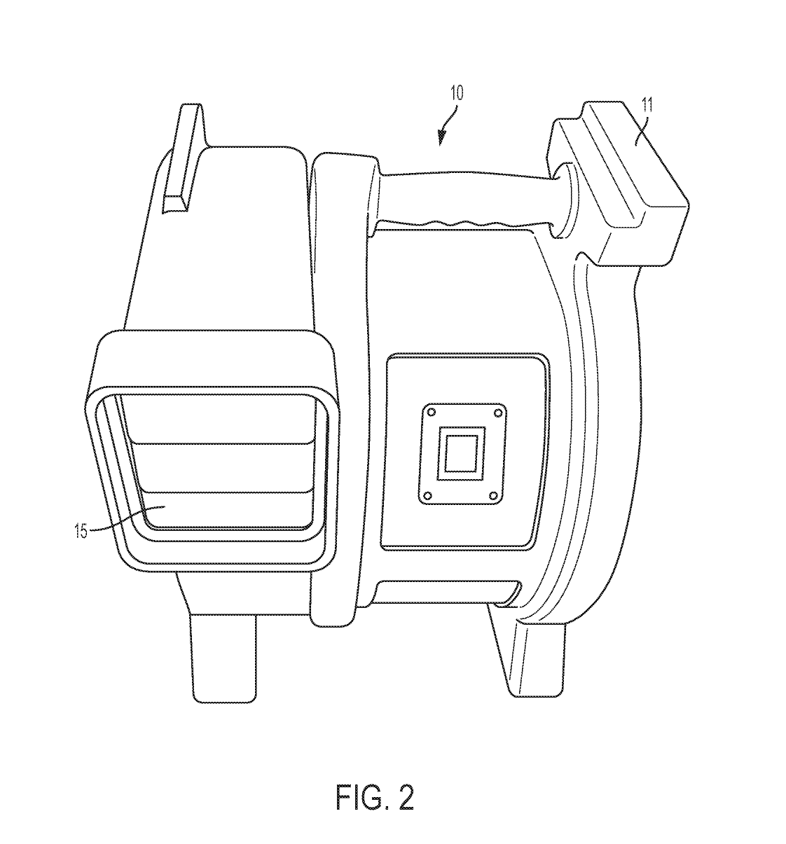

Referring next to FIG. 2, there is shown an exemplary industrial blower for use with the present invention. Blower 10 for use with system 1000 in the present invention comprises of durable housing 11. Blower 10 further comprises an electric motor (not shown) disposed within housing 11 and a propeller (not shown) functionally attached to the motor. Housing 11 of blower 10 further comprises an air intake port (not shown) and air outlet port 15. System 1000, in an exemplary embodiment, uses, as blower 10, a B-Air® Kodiak KP-1.5 blower, which produces 1,290 cubic feet per minute (“CFM”) of air with 9.8 inches of static pressure while drawing electrical amperage of less than 9 amps. Housing 11 of blower 10 may further comprise internal or external means for dampening sound. Such means may include foam disposed within housing 10 or a housing having a thickness great enough to deaden sound.

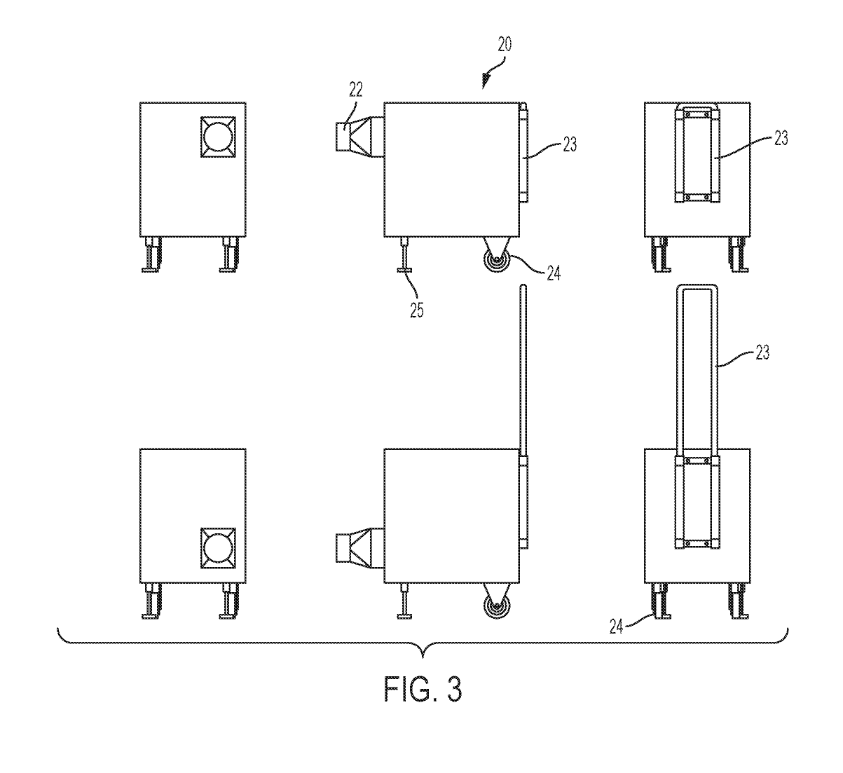

Referring now to FIG. 3, there is shown exemplary sound dampening box 20 for use with the present invention. As illustrated in FIG. 3, sound dampening box 20 is designed to fit over blower 10. Sound dampening box 20 preferably comprises of materials selected from the group consisting of aluminum and stainless steel. Generally, sound dampening box 20 comprises a generally cuboid shape. However, those of ordinary skill in the art will appreciate that blower box 20 may comprise any convenient shape suitable for manufacturing and sized largely enough to hold bower 10 therein.

In one exemplary embodiment, sound dampening box 20 comprises an air intake vent, and outlet vent 22. Preferably, sound dampening box 20 further comprises transportation means such as retractable handle 23 disposed on one side of sound dampening box 20 in conjunction with castor wheels 24 connected to the bottom of sound dampening box 20. Sound dampening box 20 may comprise as many as four wheels 24.

However, in a preferred embodiment of the present invention, sound dampening box 20 comprises two castor wheels 24 disposed on the bottom of sound dampening box 20 at or near each corner on the proximal side of the bottom of sound dampening box 20. Additionally, retractable handle 23 is disposed on one vertical side of sound dampening box 20, preferably the same side as castor wheels 24. On the bottom of sound dampening box 20, but opposite wheels 24, there is disposed retractable stopping pads 25 such that sound dampening box 20 position may pivot about wheels 24 into a stationary position. Wheels 24 preferably include locking means such as a cam lock or other generally known means for locking castor wheels. Sound dampening box 20 further comprises a lid or other access portal for placing blower 10 within sound dampening box 20.

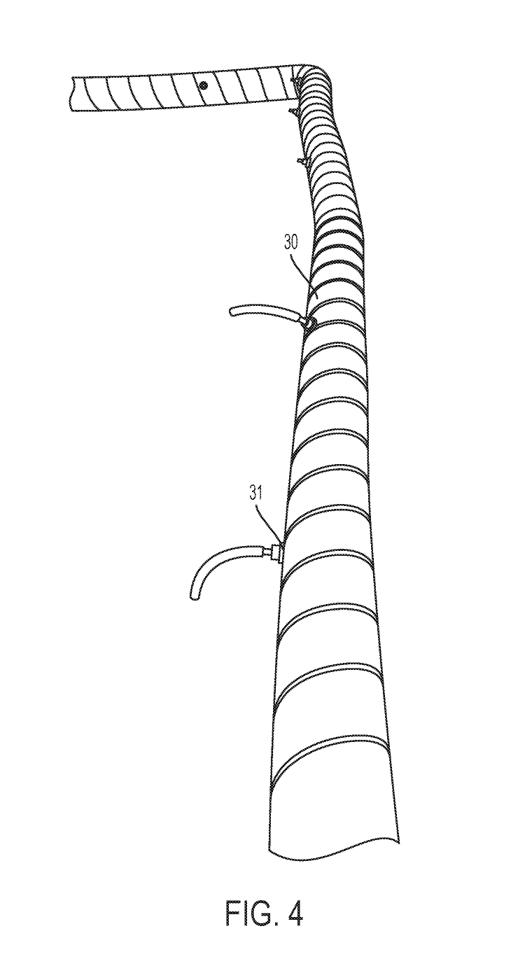

Referring now to FIG. 4, there is shown blower air duct 30 in accordance with the present invention. As illustrated in FIG. 4, blower air duct 30 preferably comprises two single-ply neopropine-coated polyester fabric plies protecting in insulation barrier reinforced with a spring steel wire helix scaffold and black external polyvinyl chloride (“PVC)”-coated polyester wear strip. In a preferred design, blower air duct 30 has an inner diameter of about 8 inches. The design of air duct 30 is particularly useful with the present invention because it allows blower air duct 30 to be linearly compressible to fit a long length as much as 25 feet into a bag having a length of about one foot long.

Another advantage of the construction of blower air duct 30 is that is not easily crushed, crimped, or pinched radially. Consequently, blower air duct 30 can be deployed around corners in a room or around furniture within a room and still function properly. In one exemplary embodiment of System 100 of the present invention, blower air duct 30 comprises an AWP-W fabric hose provided by Flex Aust Inc. Blower air duct 30 further comprises a plurality of bores 31 disposed linearly preferably at regular intervals along the extended length of blower air duct 30. Bores 31 preferably comprise a diameter of no more than 1 inch. For a blower air duct having a length of 25 feet, a preferred embodiment will include about twelve bores. Blower air duct 30 may further comprise two rows of bores 31 disposed around the exterior of duct 30. In a preferred embodiment the two rows of bores 31 are disposed so that both rows are unobstructed when duct 30 is on the floor at an angle of below 180°.

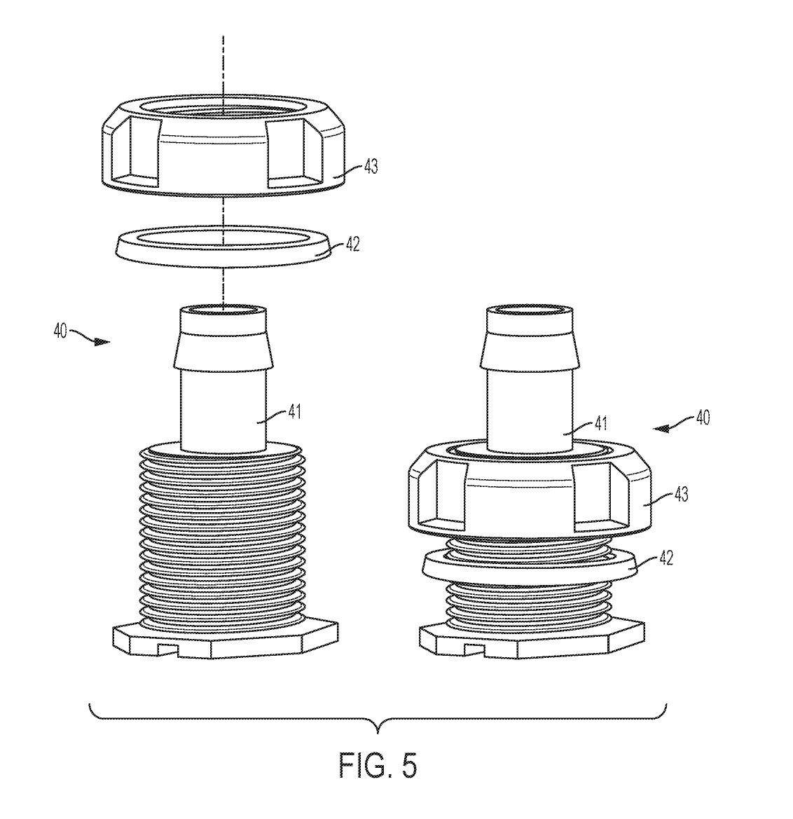

Referring now to FIG. 5, there is shown an assembly view and an exploded view of nozzle 40 in accordance with the present invention. As illustrated in FIG. 5, nozzle 40 preferably comprises nozzle body 41, gasket 42, and fastening ring 43. Nozzle body 41 comprises a cylindrical shape having external threads and a generally flat octagonal base. Nozzle body 41 further comprises an elongated tip rigidly attached to and extending from the threaded cylindrical portion of body 41 opposite the oxagonal base. Body 41 of nozzle 40 further comprises a cylindrical bore having an inner diameter of about ½-inch. Nozzle 40 further comprises an O-ring-shaped gasket 42 and nozzle ring 43. Nozzle ring 43 comprises a generally cylindrical shape with having a threaded inner diameter sized to threadably connect nozzle 43 with the exterior of the cylindrical portion of nozzle body 41.

As illustrated in the exploded view of FIG. 5, gasket 42 is placed over the threaded portion of body 41 of nozzle 40. Thereafter ring 43 is threadably connected over the cylindrical portion threadably connected to body 41 of nozzle 40 and tightened until it seals against gasket 42.

Referring again to FIG. 4, it is shown that each bore 31 is disposed between the interior and exterior of blower air duct 30 ideally contains a nozzle 40. As illustrated in FIG. 4, body 41 of nozzle 40 is disposed through each bore 31 of blower air duct 30 such that gasket 41 of nozzle 40 is disposed against the interior of blower air duct 30 and the remaining portion of body 41 of nozzle 40 extends through bore 31 of blower air duct 30. Thereafter, ring 43 is threadably connected to body 41 of nozzle 40 and ring 33 is screwed down until it clamps on the material of blower air duct 30 thereby providing a releasably sealed connection between nozzle 40 and blower air duct 30 via bore 31. As further illustrated in FIG. 4, each bore 31 is releasably connected to nozzle 40, and each bore 31 and nozzle 40 is fluidly connected to the interior of blower air duct 30. Additionally, in some embodiments of the present invention, more than one row of bores is disposed along the extended length of blower air duct 30. As illustrated in FIG. 4, the first line of nozzles is disposed on one side of blower air duct 30 and a second row can be disposed through a line of bores that is disposed preferably greater or less than 180 degrees from the first line of nozzles.

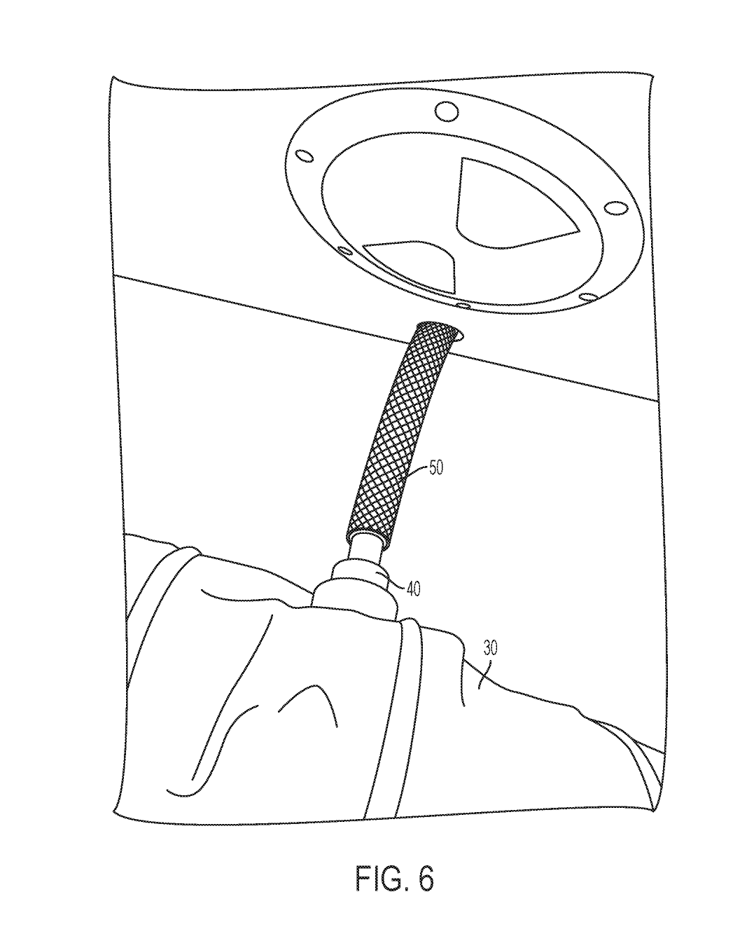

Referring now to FIG. 6, there is shown a flexible nozzle hose 50 in accordance with System 1000 of the present invention. As illustrated in FIG. 6, flexible nozzle hoses 50 are releasably attached to the distal end of each nozzle 40. Flexible nozzle hoses 50 preferably comprise PVC or another durable flexible material. Each hose 50 may be of any desired length. Preferably, each hose 50 is attached on one side to a nozzle 40. On one side of blower air duct 30 (as shown in FIG. 4) nozzle hoses 50 are manipulated such that the free end of each nozzle 50 can be inserted into open spaces or within or otherwise directed toward a wall from which moisture is to be extracted. In one exemplary embodiment, nozzles 40 may also include nozzle hoses 50 adapted to be directed towards flooring or other objects within a walled-in space that also require moisture removal.

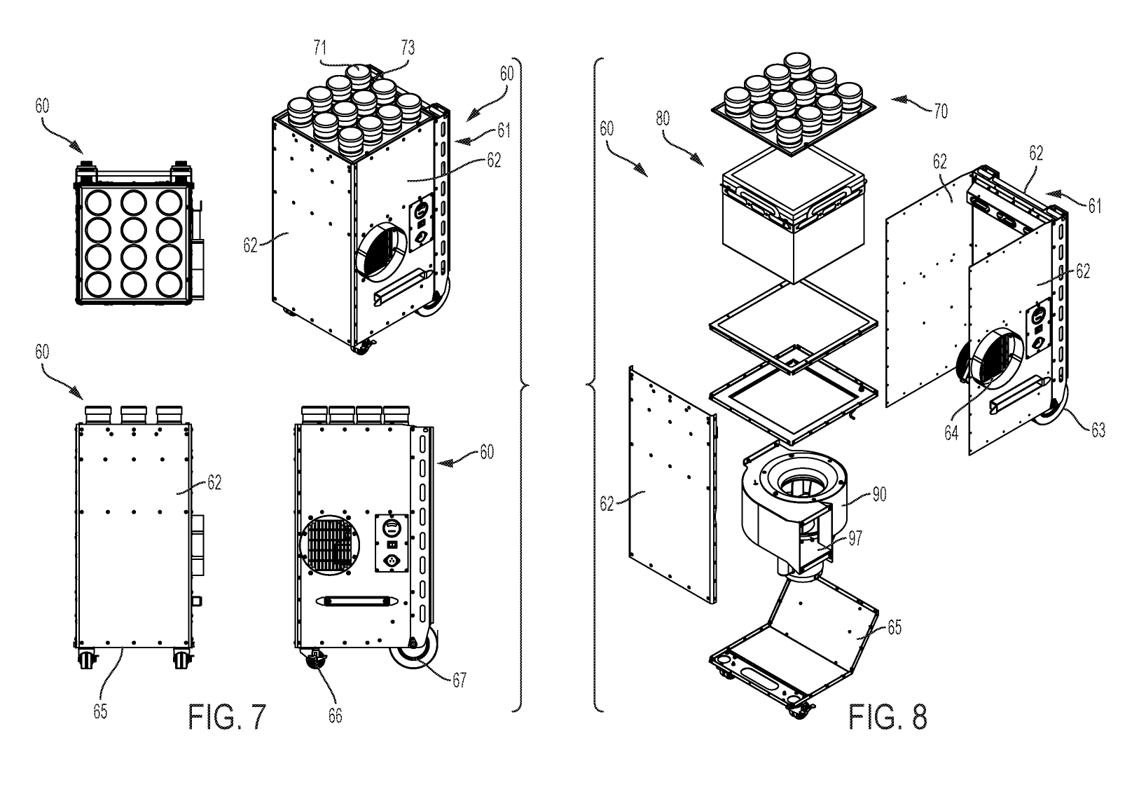

Turning now to FIG. 7, there is shown a vacuum device in accordance with the present invention. In the present invention air scrubber/vacuum device 60 preferably comprises a durable housing made of lightweight but strong material such as aluminum or high-strength plastic. As illustrated in FIG. 1, vacuum air ducts 120 are releasably, selectively attached at one end to air tubes/ports 73. Each vacuum air duct 120 ideally comprises a smaller inner diameter than vacuum than blower air duct 30. In one preferred embodiment of the System 1000 of the present invention, vacuum 60 comprises an Omniaire 1500 HS air filtration machine.

Referring now to FIG. 7, they were shown a perspective view, a top view, a side view, and a rear view, respectively, of air intake scrubber assembly (a/k/a vacuum device) 60. As illustrated in FIG. 7, air scrubber assembly 60 generally comprises a housing 61 formed of a durable, lightweight, and corrosion resistant material, such as aluminum or stainless steel. As further illustrated in FIG. 7, air scrubber housing 61 comprises front, rear and side panels 62 along with bottom panel 65. Housing 61 further comprises, in a preferred embodiment, front wheels 66 and rear wheels 67 disposed along the bottom of housing 61 so that a user may easily remove air scrubber assembly 60 to a desired location.

Referring now to FIG. 8, is an exploded perspective view of air scrubber assembly 60. As illustrated in FIG. 8, air scrubber assembly 60 generally comprises top air inlet plate assembly 70, HEPA filter assembly 80, and fan assembly 90 which further comprises the fan housing 94 and motor assembly 100.

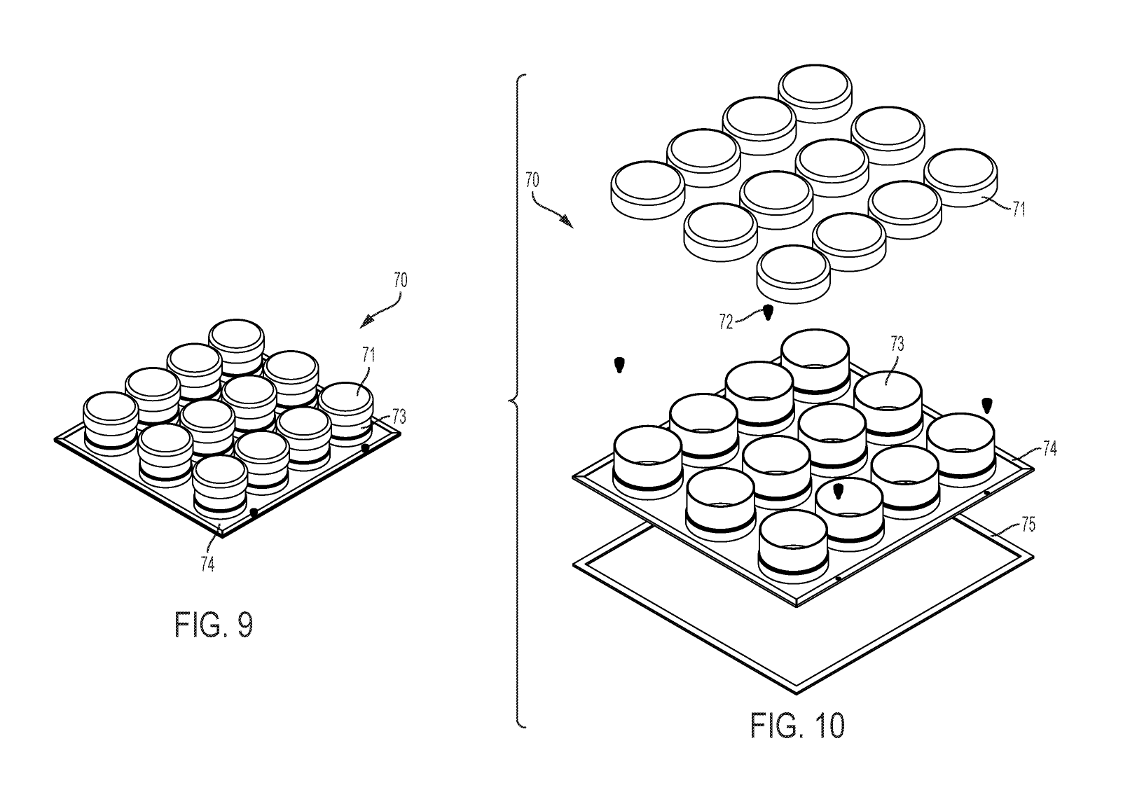

Referring now to FIG. 9, they were shown a perspective view of top inlet plate 70. As further illustrated in FIG. 9 top inlet plate assembly 70 comprises a plurality of vacuum tubes (or ports) 73 with removable caps 71 disposed thereon. As further illustrated in FIG. 9, in a preferred embodiment of the present invention, vacuum tubes 73 are regularly spaced through top inlet plate weldment 74.

Turning now to FIG. 10, there is shown an exploded view of top inlet plate assembly 70. As illustrated in FIG. 10, inlet plate assembly 70 generally comprises weldment 74 having a plurality of vacuum tubes 73 disposed there through, preferably in a regular arrangement. Inlet plate assembly 70 further comprises a plurality of individual vacuum tube caps 71 designed to cover any unused vacuum tubes 73. As illustrated in both FIG. 9 and FIG. 10, vacuum tubes 73 are preferably cylindrically shaped and extend vertically from weldment 74. However, those of ordinary in the art will appreciate that vacuum tube 73 may come in any desired geometric shape, and it may extend any distance from weldment 74. Moreover, vacuum tubes 73 need not utilize a regular arrangement. Any number or arrangement of vacuum tubes 73 is suitable for the present invention. However, it is preferred to maximize the number of possible attachment points for tubes. As further illustrated in FIG. 10, top inlet plate assembly 70 further comprises foam seal 75. Weldment 74 and seal 75, as illustrated in FIG. 10, may be connected to one another by any suitable means such as for example, removal fasteners 72 as shown in FIG. 10.

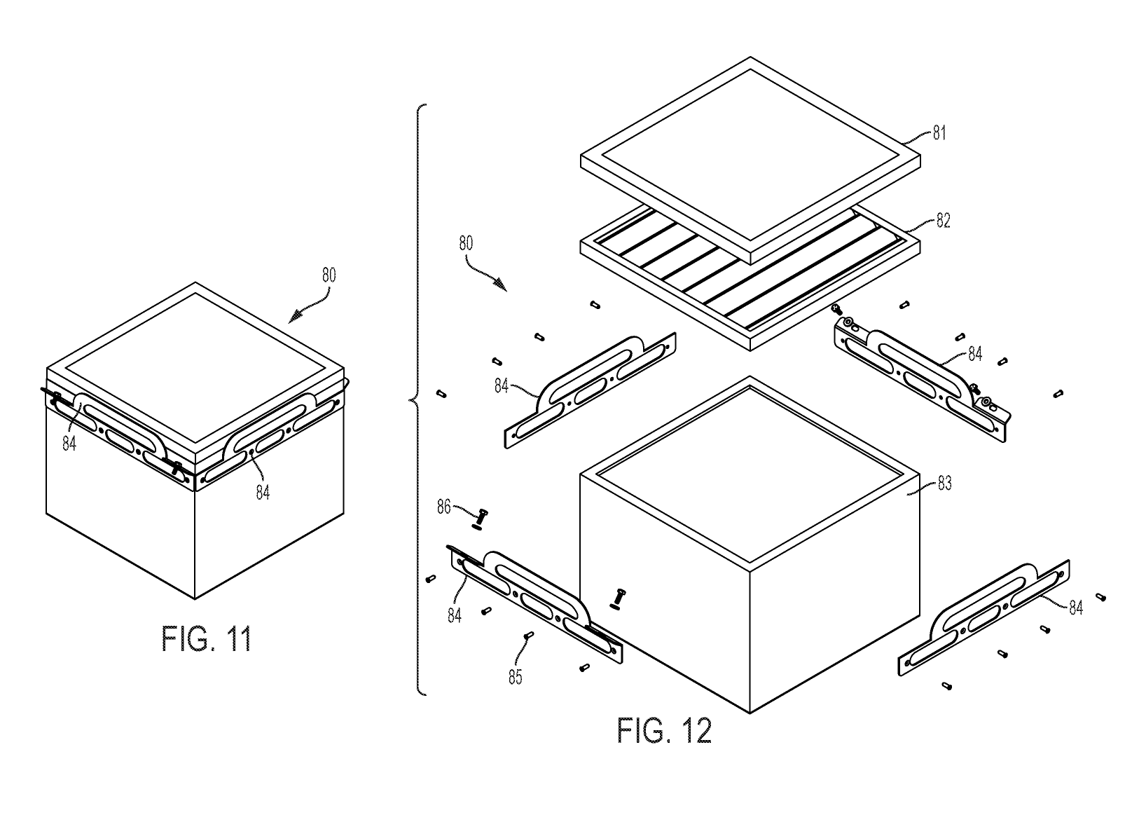

Referring now to FIG. 11, there is shown HEPA filter assembly 80. HEPA filter assembly 80 preferably compromises a cuboid shape, however, those of ordinary skill in the art will appreciate that HEPA filter assembly 80 may come in any suitable geometric form. As further illustrated in FIG. 80, HEPA filter assembly 80 further compromises a lifting handle 84 disposed on each face of cube shaped HEPA filter 80.

Referring now to FIG. 12, there is shown a disassembled view of HEPA filter assembly 80. As illustrated in FIG. 12, HEPA filter assembly 80 generally compromises a top pre-filter 81, a secondary guideplate filter 82, HEPA filter box 83, and a plurality of lift handles 84. Pre-filter 81 is disposed on top of secondary filter 82 which is itself disposed on top of HEPA filter box 83. Lift handles 84 are removably attached to each face of each sidewall of HEPA filter box 83 by conventional means such as fasteners 85 and 86 shown in FIG. 12.

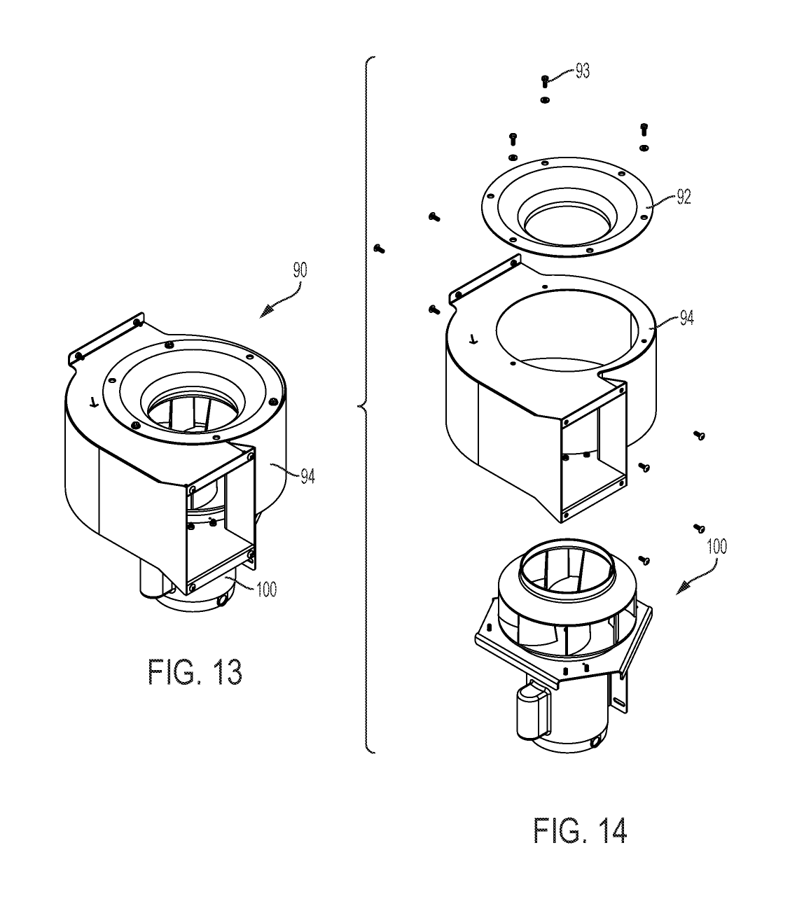

Referring now to FIG. 13, there is shown a perspective view of fan housing assembly 90. As shown in FIG. 13, fan housing assembly 90 generally compromises fan housing weldment 94 with motor assembly 100 disposed therein.

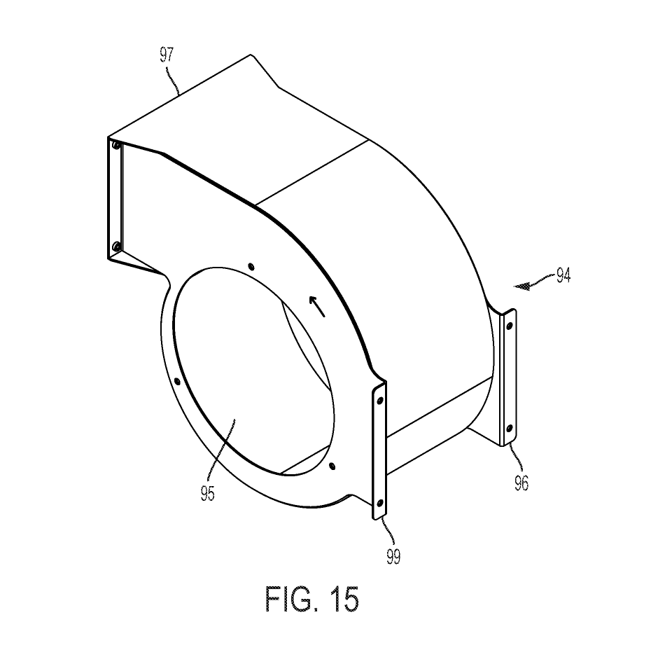

Referring next to FIG. 14, there is shown an exploded view of fan housing assembly 90. As illustrated in FIG. 14, fan housing assembly 90 generally compromises fan housing weldment 94, and fan motor assembly 100, and fan inlet cone 92. As shown in FIG. 14, fan motor assembly 100 is disposed with a cylindrically shaped central bore of fan housing weldment 94. Fan inlet cone 92 is disposed on top of fan housing weldment 94. As further illustrated in FIG. 14, various fasteners 96 are used to connect fan inlet cone 92 to the top of fan housing 94 and to secure fan motor 100 within fan weldment 94.

Referring now to FIG. 15, there is shown a perspective view of fan housing weldment 94. As illustrated in FIG. 15, fan housing weldment 94 compromises a generally cylindrical shape having a centralized cylindrical bore 95 disposed through the longitudinal axis of weldment 94. Weldment 94 further compromises a pair of base rails 96 adapted to allow weldment 94 to be attached to the inside of any panel 62 of air scrubber assembly housing 61, as shown, for example, in FIG. 8.

As further illustrated in FIG. 8, fasteners, 72 or 93 are used to releasably connect weldment 94 to the inside of a Panel 62 of air scrubber assembly housing 61.

As further illustrated in FIG. 15 fan housing weldment 94 further compromises Air Outlet 97. Air Outlet 97 is fluidly connected to an inlet within central bore 95 of fan housing weldment 94. Although though the inlet is not illustrated in FIG. 15, it is fluidly connected to outlet 97 of fan housing weldment 94. Accordingly, when motor fan assembly 100 is disposed within the central bore of fan weldment 94 an air flow can be generated by fan motor assembly 100 to flow through weldment 94 as illustrated by the arrow shown on weldment 94 in FIG. 15. Thus, weldment 94 is adapted to force air from fan assembly 100 through outlet 97. Outlet 97 is then fluidically connected to housing outlet 64 as illustrated in FIG. 8.

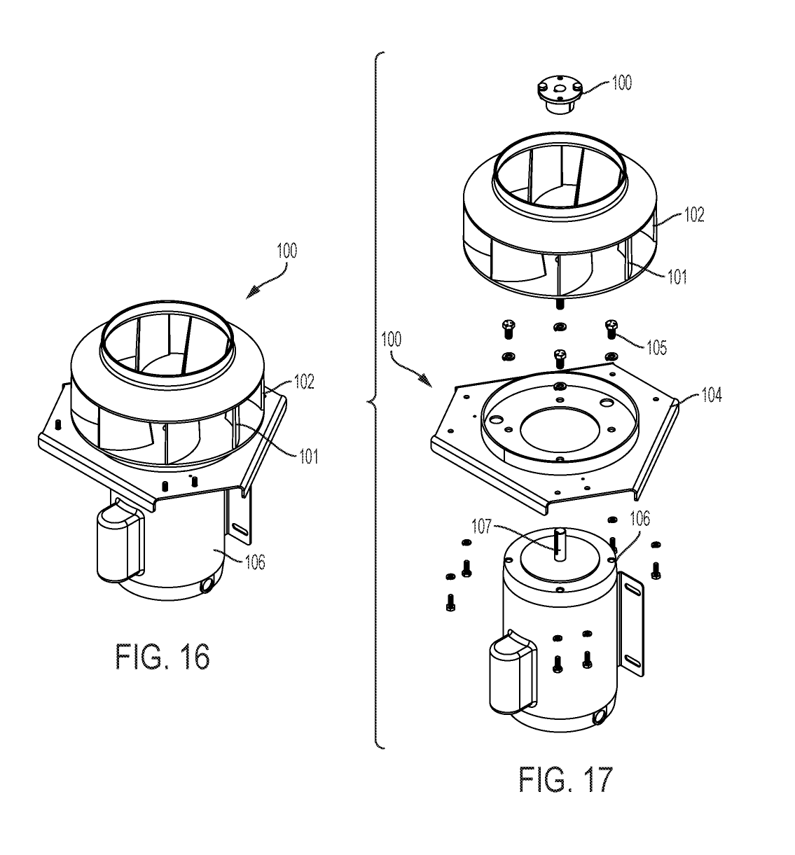

Referring now to FIG. 16, there is shown a perspective view of motor fan assembly 100. As shown in FIG. 16, motor fan assembly 100 generally compromises a plurality of curved fan blades 101 disposed on the exterior of a cylindrical fan adapted to spin about an imaginary longitudinal axis disposed through the central axis of fan 102. Fan Assembly 100 further compromises fan motor 106 (preferably a 1-to-1½ horsepower fan motor) functionally attached to cylindrical fan 102.

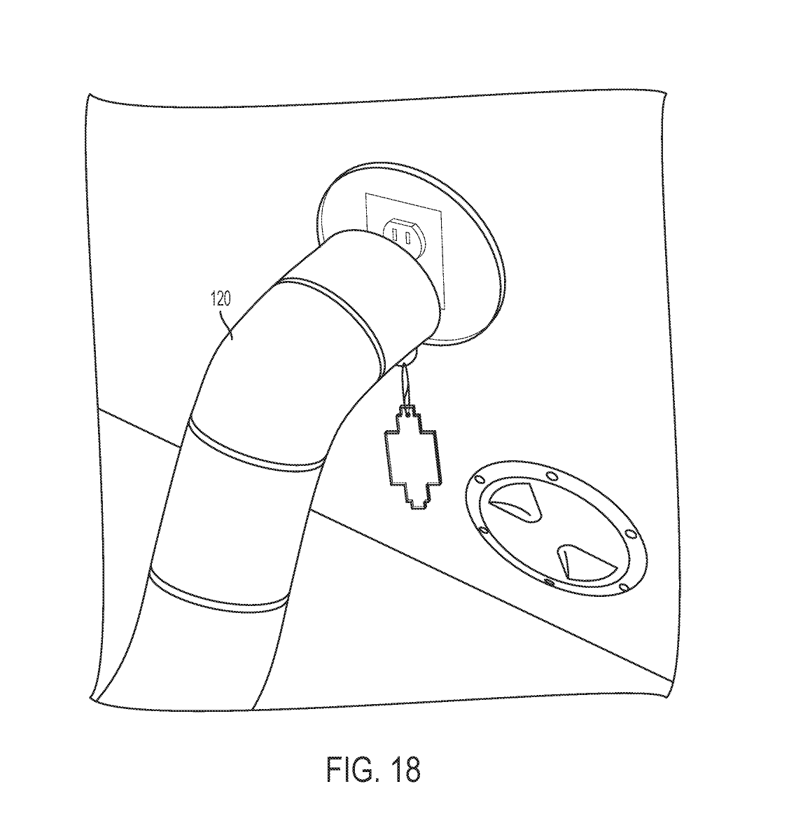

Referring now to FIG. 17, there is shown an exploded view of motor fan assembly 100. As illustrated in FIG. 17, motor fan assembly 100 generally compromises fan sub-assembly 102 having a plurality of external curved blades 101. Fan sub-assembly 102 is disposed on top of releasably disposed on top of Motor Mount Plate 104 by one or more fasteners 105. The combination of fan 102 and mounting plate 104 is then disposed on top of top of Motor 106. Motor 106 is preferably an electric motor connectible to a power source (not shown) by conventional means.

Motor 106 further compromises a rotating cylindrical shaft 107 adapted to spin fan 102 such that blades 101 create air that flows through weldment 94 as illustrated generally in FIGS. 8, 13 and 15. As further illustrated in FIG. 17, motor fan assembly 100 further compromises bushing 108 disposed through the central axis of Fan Assembly 102 and through a central board of mounting plate 104 for the purpose of engaging with shaft 107 of motor 106. Motor 106 is operating, it spins fan 102 in the desired direction.

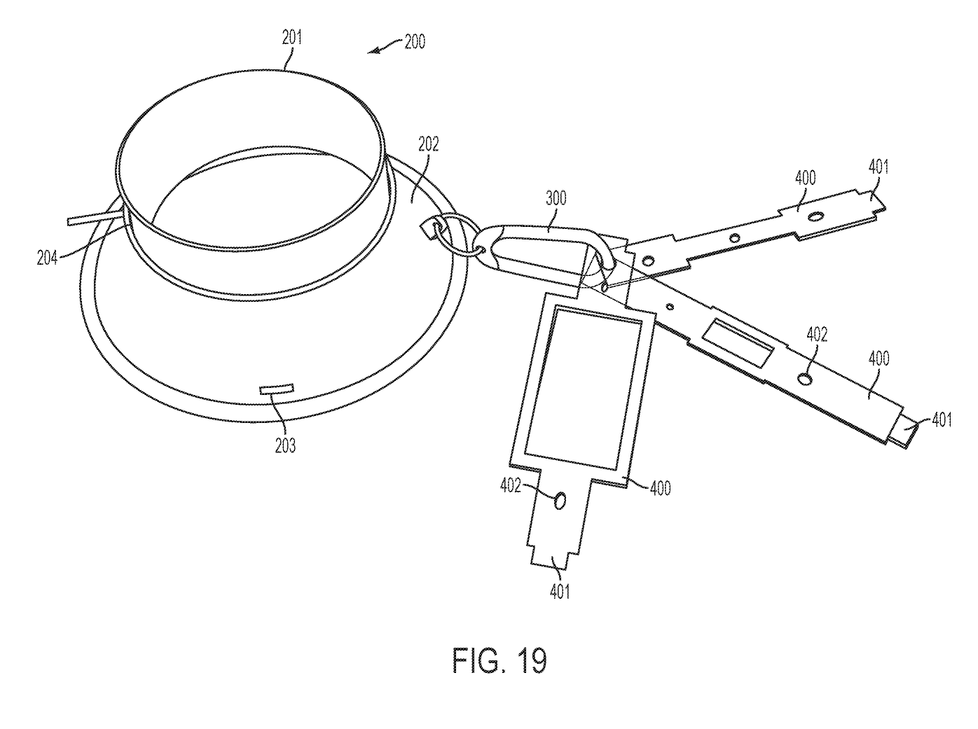

FIG. 19 shows a top perspective view of an exemplary sealing boot 200 according to the present invention. As illustrated in FIG. 19, sealing boot 80 comprises a generally conical first section 201 and an outwardly tapered conical second section 202. Sealing boot 200 can be manufactured from any material sufficiently flexible to affect the desired seal. For electrical installations a dielectric material such as natural rubber, neoprene, silicone rubber, styrene-butadiene rubber, fluorocarbon resin, polyacrylate, polyurethane, and the like, are preferred. From the standpoint of its dielectric properties, cost, and ease of manufacture, moldable rubber is particularly preferred.

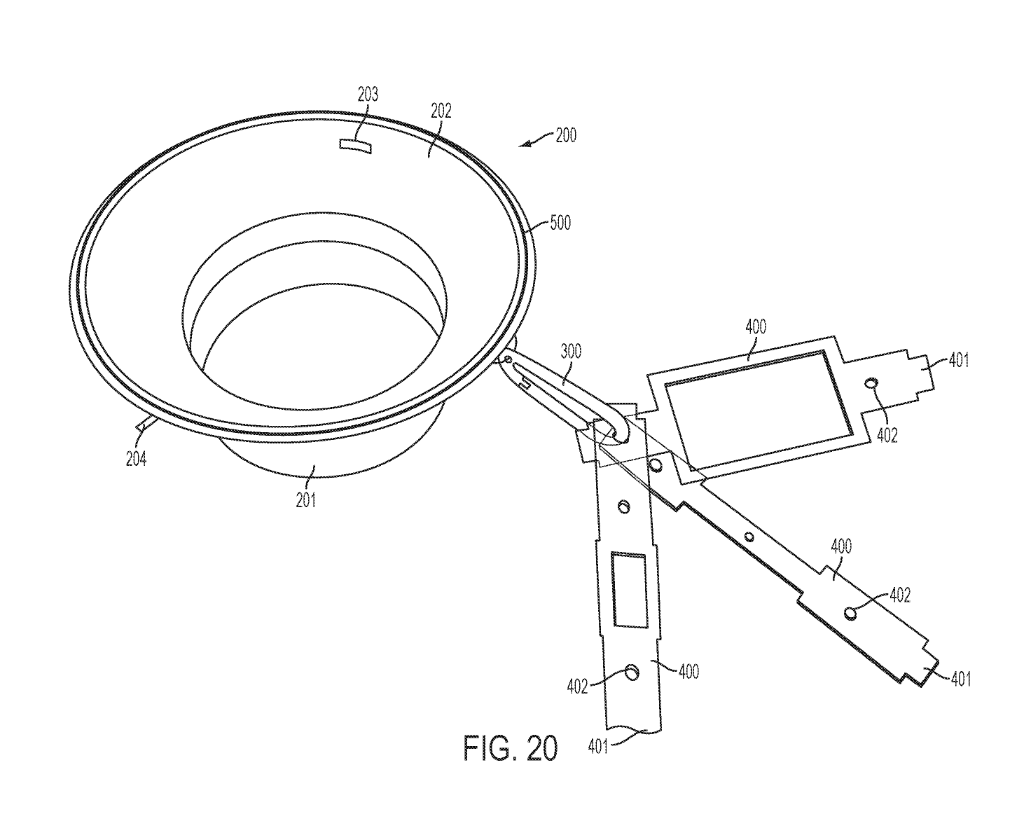

Referring still to FIG. 19, sealing boot 200 of the present invention further comprises at least one releasably attachable mounting bracket 400. Mounting bracket 400 generally comprises means to selectively securely attach mounting bracket 400 to the front of a common electrical outlet. In one exemplary embodiment, a plurality of clips of various designs are attached to boot 200 via a releasable clip 300, ring, or combination of the same as illustrated in FIGS. 19 and 20.

Referring now to FIG. 20, there is shown a bottom perspective view sealing boot of the present invention. As illustrated in FIG. 20, sealing boot 200 further comprises sealing ring 500 disposed around the inner perimeter of tapered conical section 202 of sealing boot 200.

Turning briefly again to FIGS. 19 and 20, there are shown a plurality of mounting brackets 400. Each mounting bracket 400 generally comprises an elongated cuboid shape having opposing ends. Each end of mounting bracket 84 further comprises a tab 401. Mounting brackets 400 generally comprises a thermoplastic or thermoset material such a polystyrene or the like. Preferably, mounting brackets 400 comprise a mostly transparent and electrically nonconductive material. However, those of skill in the art will appreciate a metal bracket may be used within the scope of the present invention.

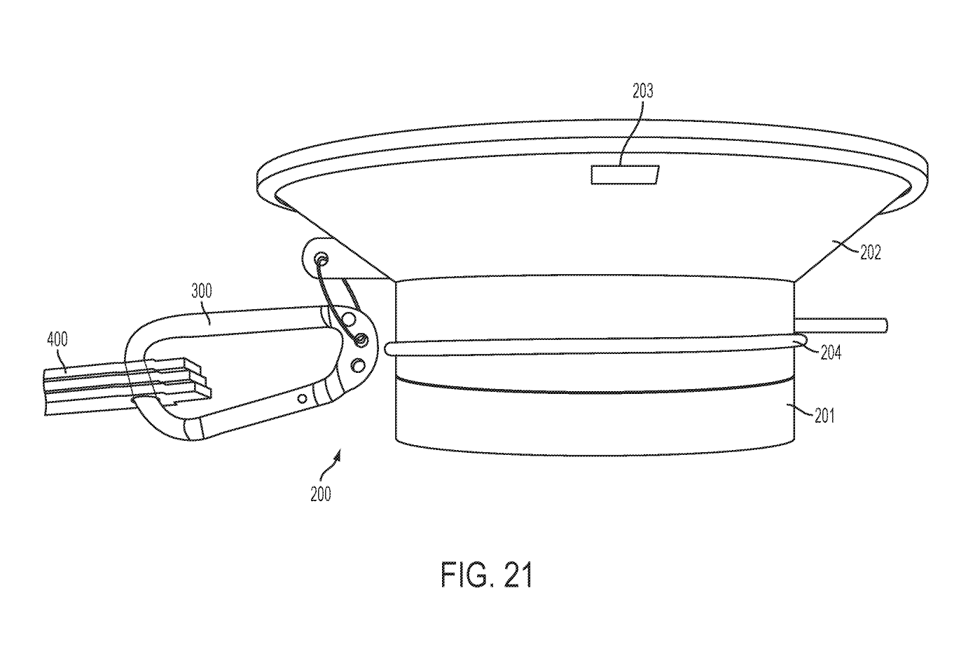

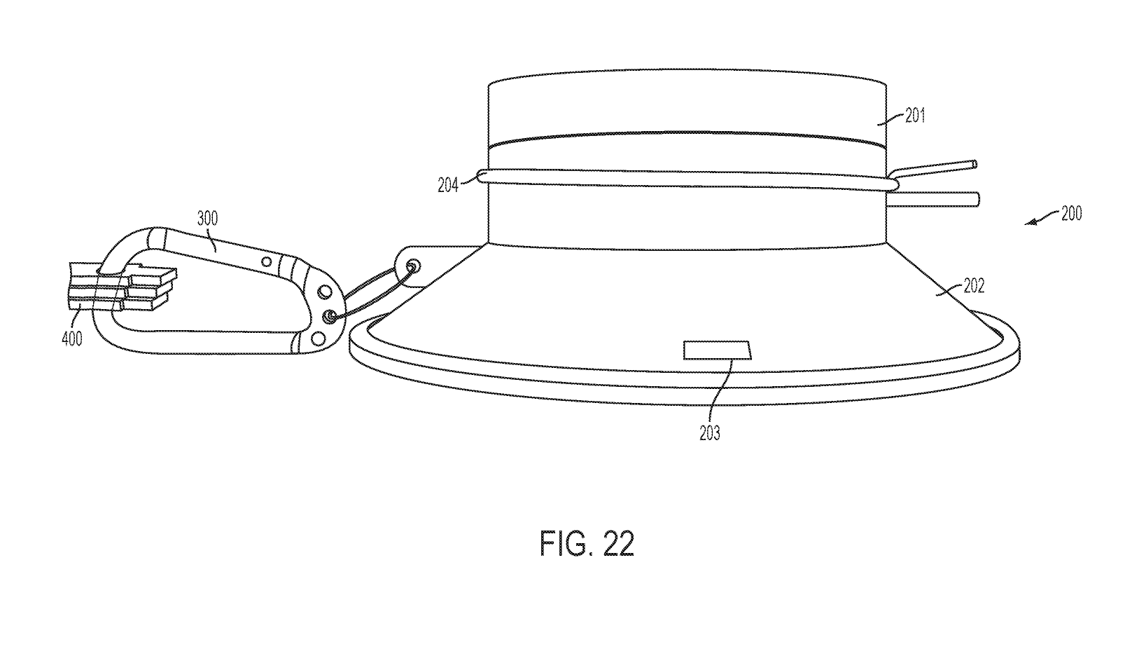

FIGS. 21 and 22 show side elevational views of sealing boot 200. As shown in FIGS. 21 and 22, sealing boot 200 comprises straight conical portion 201 and outwardly tapered conical portion 202. Tapered conical portion 202 further comprises tab receiving slots 203.

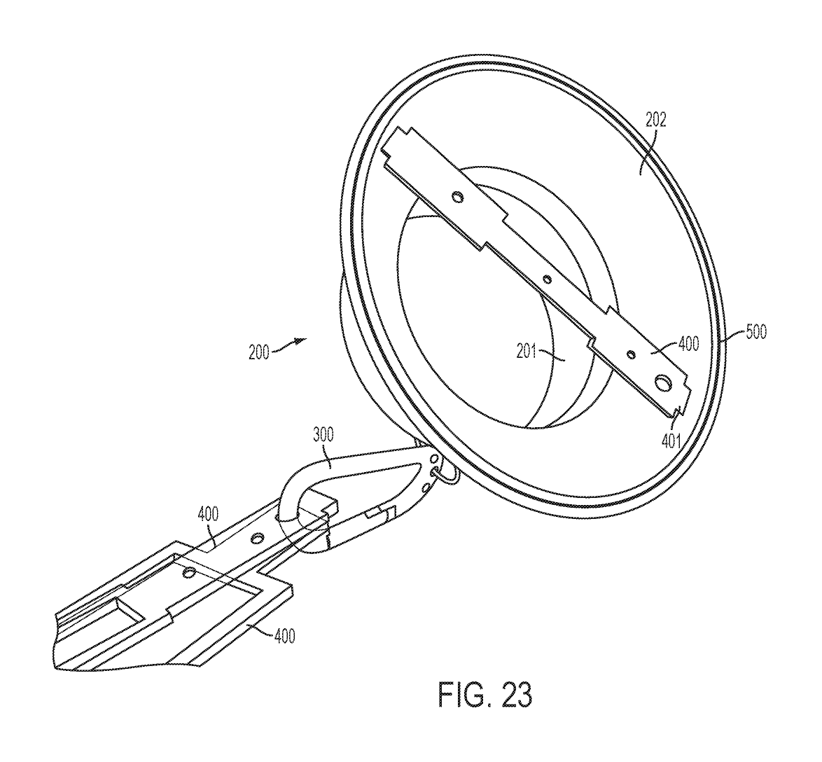

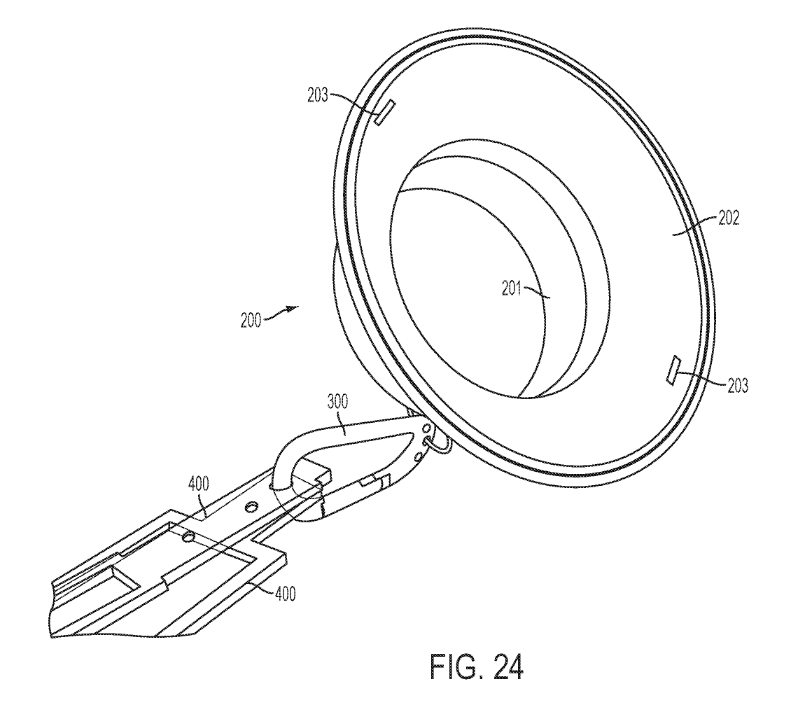

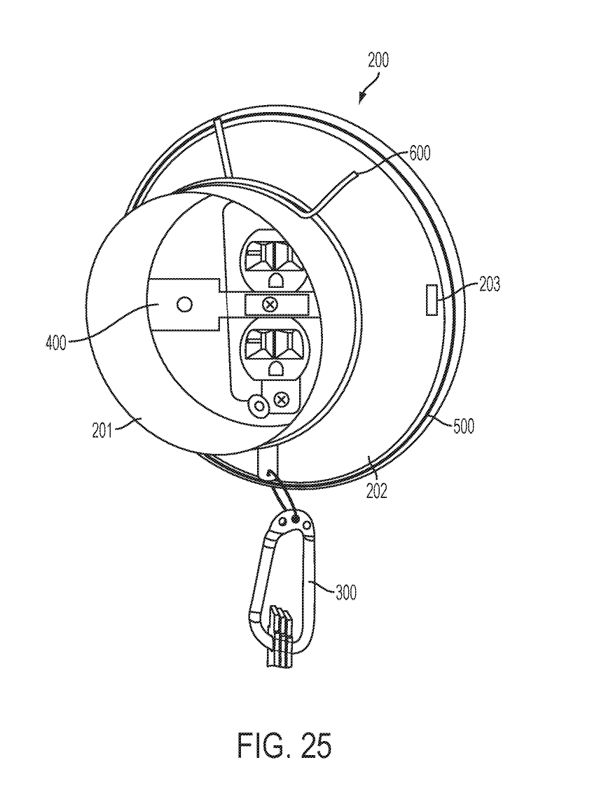

Referring now to FIG. 23 and FIG. 24, there are shown bottom perspective views of sealing boot 200. FIG. 23, shows sealing boot 200 with mounting bracket 400 attached. As illustrated in FIGS. 19 and 20, bracket 400 further comprises opposing tabs 401. Turning again to FIG. 23, tabs 401 are selectively inserted into tab receiving slots 203 of tapered conical portion 202 of sealing boot 200 to releasably connect a selected bracket 400 to sealing boot 200 across the inner diameter of outwardly tapered conical portion 202.

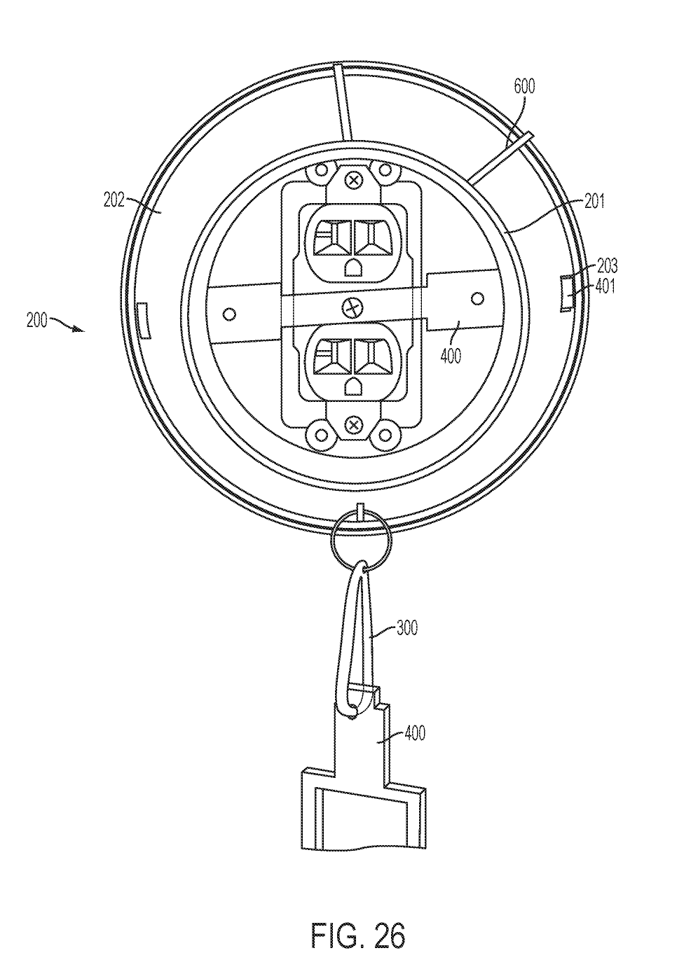

Turning now to FIG. 25 and to FIG. 26, there are shown a top perspective view and top view, respectively, of sealing boot 200 to a common wall outlet. As illustrated in FIGS. 25 and 26, mounting bracket 400 further comprises means to securely releasably attach mounting bracket 400 to the front of an electrical outlet. Generally, said means comprises a bore 402 through which a screw can be used to secure bracket 400 to an electrical outlet. Mounting brackets 400 of the present invention may be adapted to be used in connection with any electrical outlet or switch, such as a duplex receptacle, a toggle switch, or decora style electrical device.

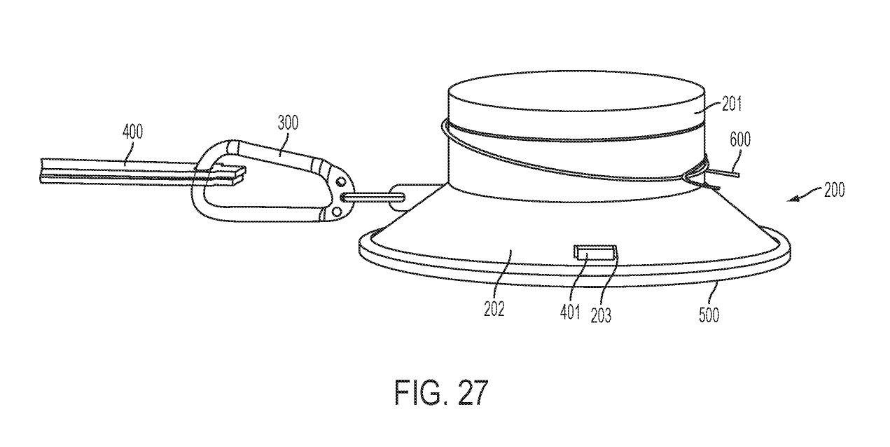

FIG. 27 shows a side elevation view of sealing device 200 attached to a wall. In use, an air mover such as a vacuum or blower is attached to a flexible hose. The hose is carried to or directed toward the desired point of use. In situations where it is desirable to remove air from the interior a wall, air is often forced into or out of the wall around an electrical outlet. By use of the present invention, a flexible hose as described herein can be releasably attached to sealing boot 200. As illustrated in FIG. 27, sealing boot 200 may further comprise an exterior coil clip 600 for attaching a hose to sealing boot 200. Those of skill in the art will appreciate that other securing means, such as rubber bands, string, cord, tape, and zip ties may also be used. Additionally, the hose and or straight conical portion 201 may comprise cooperating protrusions and indentions to allow for a sufficiently rigid connection between the hose and sealing boot or the hose may be comprised of an elastic material that readily secures to the exterior of sealing boot 200. Of course, those of skill in the art will also appreciate that the present sealing boot 200 may also be used with a less rigid connection between it and any corresponding hose or sealing boot 200 may be directly connected to a desired air mover.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A system for removing moisture from an interior wall of building, said system comprising:
a blower, said blower comprising:
a housing, said housing having an air intake port and an air outlet port;
an electric motor, said motor disposed within said housing; and
an impeller, said impeller functionally connected to said motor;
a flexible blower air duct, said air duct comprising:
an interior surface;
an exterior surface; and
at least one bore disposed through said air duct between said interior surface and said exterior surface;
at least one nozzle, each said at least one nozzle removably attached to said air duct about each said at least one blower bore; and
at least one flexible air hose, each said at least one air hose having:
a first end, said first end removably attached to each said nozzle; and
a second end.

2. The system of claim 1, wherein said blower air duct linearly compressible and radially incompressible.

3. The system of claim 1, wherein the blower air duct comprises a shape selected from the group consisting of generally cylindrical and generally cuboid.

4. The system of claim 1, wherein the blower air duct comprises PVC and a scaffold comprising a metal material.

5. The system of claim 1, wherein said blower air duct comprises a plurality of bores disposed along a single line at regular intervals.

6. The system of claim 1, wherein said system further comprises:
a sound dampening box disposed around said blower, said box having:
an air intake vent fluidically connected to said air inlet port of said housing; and
an air outlet vent fluidically connected to said air outlet port of said housing.

7. The system of claim 1, wherein said housing further comprises means for dampening sound.

8. A system for removing moisture from an interior wall of building, said system comprising:
a blower, said blower comprising:
a housing, said housing having an air intake port and an air outlet port;
an electric motor, said motor disposed within said housing; and
a propeller, said propeller functionally connected to said motor;
a flexible blower air duct, said air duct comprising:
an interior surface;
an exterior surface; and
at least one bore disposed through said air duct between said interior surface and said exterior surface;
at least one nozzle, each said at least one nozzle removably attached to said air duct about each said at least one blower bore;
at least one flexible air hose, each said at least one air hose having:
a first end, said first end removably attached to each said nozzle; and
a second end;
a vacuum, said vacuum comprising:
a housing, said housing having at least one an air intake port and an air outlet port;
an electric motor, said motor disposed within said housing; and
an impeller, said impeller functionally connected to said motor;
an electrical outlet boot, said boot removably disposed over an electrical outlet; and
a vacuum air duct, said vacuum air duct having:
a first end, said first end of said vacuum air duct attached to said air intake port; and
a second end, said second end of said vacuum air duct attached to said boot.

9. The system of claim 8, wherein said blower air duct linearly compressible and radially incompressible.

10. The system of claim 8, wherein the blower air duct comprises a shape selected from the group consisting of generally cylindrical and generally cuboid.

11. The system of claim 8, wherein the blower air duct comprises PVC and a scaffold comprising a metal.

12. The system of claim 8, wherein said blower air duct comprises a plurality of bores disposed along a single line at regular intervals.

13. The system of claim 8, wherein said system further comprises:
a sound dampening box disposed around said blower, said box having:
an air intake vent fluidically connected to said air inlet port of said housing; and
an air outlet vent fluidically connected to said air outlet port of said housing.

14. The system of claim 8, wherein said housing further comprises means for dampening sound.

15. The system of claim 8, wherein said vacuum comprises a plurality of air inlet ports.

16. The system of claim 8, wherein said system further comprises a plurality of vacuum hoses.

17. The system of claim 8, wherein said vacuum air duct linearly compressible and radially incompressible.

18. The system of claim 8, wherein said boot comprises: a generally cylindrical tube having a first end having a first diameter and a second end having a second diameter where said second diameter larger than said first diameter; a tapered wall that connects said first and second ends; at least two slots disposed through said tapered cylindrical wall; a gasket disposed about the a perimeter of the said second end; at least one bracket, said bracket comprising at least two tabs, said tabs sized and oriented to be inserted into said slots, where said bracket is disposed across the diameter of said second end; means for selectively and releasably attaching said bracket to an electrical outlet.
